(19) United States
(12) Patent Application Publication
(10) Pub. No.: US 2022/0267223 A1
(43) Pub. Date: Aug. 25, 2022

(54) POLYHALITE COMPOSITE FERTILISER PELLET

(71) Applicant: York Potash Ltd, London (GB)

(72) Inventors: Timothy David Lewis, Yorkshire (GB); Robert John Meakin, Yorkshire (GB)

(21) Appl. No.: 17/630,982

(22) PCT Filed: Jul. 29, 2020
(86) PCT No.: PCT/GB2020/051815

§ 371 Date: Jan. 28, 2022

(30) Foreign Application Priority Data
Jul. 30, 2019 (GB) 1910866.1

(51) Int. Cl. C05D 1/02; C05G 5/30; C05D 9/02

(52) U.S. Cl. CPC C05D 1/02; C05G 5/30; C05D 9/02

(57) ABSTRACT

A fertiliser pellet comprising: a first fertiliser composition capable of providing (a) two or more alkali metal and/or alkaline earth metal nutrients and (b) sulphur; a second fertiliser composition capable of providing a first micronutrient; and a third fertiliser composition capable of providing a second micronutrient, the third fertiliser composition having a lower solubility than the second fertiliser composition.

This invention relates to the composition of fertiliser pellets.

A common way to supplement the nutrients that are available to plants is to treat a seedbed, field or other growing medium with fertiliser products in the form of agglomerated pellets. Pelletised products can have the advantages of being stable, easy to spread using conventional horticultural or agricultural machinery, and readily dispensed at a desired application rate.

A wide range of fertiliser compositions are available. The effectiveness of a particular fertiliser composition depends on factors including the type of plants for which it is used, the state of maturity of the plants, the existing state of the growing medium, and the environmental conditions.

Key plant nutrients include nitrogen, phosphorus, potassium, calcium, magnesium and sulphur. These are generally known as fertiliser elements that are macronutrients. In a fertiliser composition these individual nutrient elements may be incorporated through their inclusion in any of a number of chemical compounds. It is becoming increasing desirable for a fertiliser composition to also include at least one fertiliser element that is a micronutrient. Fertiliser elements that are considered to be micronutrients include zinc, boron, manganese, molybdenum, copper, iron, sodium, nickel, chlorine, cobalt, silicon, vanadium and selenium. The micronutrients that are selected for a particular growing medium may be selected based on the particular deficiencies in that growing medium. Although different compounds may include the same underlying nutrient element the bioavailability of those nutrient elements may differ depending on the mechanism by which the compound breaks down.

In order to provide multiple nutrients a grower may apply multiple distinct fertiliser compositions or alternatively a single multi-nutrient fertiliser composition. In order for a multi-nutrient composition to be effective its constituent compounds must be in suitably balanced proportions and must be capable of acting effectively even in the presence of the other constituents. This effectiveness may rely on factors other than the contents of the fertiliser: for example the presence of environmental water, heat or certain microbiota. The effectiveness on plants of multiple-nutrient fertilisers, particularly when dependent on environmental factors, is difficult to predict. However, if a multi-nutrient fertiliser composition is effective then it has the advantage that it requires only a single spreading operation to apply it to a crop.

Certain minerals, particularly evaporite minerals, can be used as sources of nutrients such as potassium, calcium, magnesium and sulphur. For example, Gypsum can be pelletised and used as a source of calcium and sulphur.

Polyhalite is an evaporite mineral. It is a complex hydrated sulphate of potassium, calcium and magnesium of general formula K₂Ca₂Mg(SO₄)₄.2H₂O. Deposits of polyhalite occur in, amongst other countries, Austria, China, Germany, India, Iran, Turkey, Ukraine, the UK and the USA.

Polyhalite has the capacity to be valuable as a source of agricultural fertiliser as it can potentially be used to provide a mix of four of the main macronutrients. In some prior art processes it has been proposed to decompose natural polyhalite to extract specific nutrients. See, for example, WO 2013/074328, U.S. Pat. Nos. 1,946,068 and 4,246,019. However, intact polyhalite is also usable as a fertiliser, being able to supply sulphur, potassium, calcium and magnesium to the soil.

Mineral polyhalite can be spread in raw, crushed form. That minimises processing costs, but it has a number of disadvantages. Once applied to the soil the raw mineral takes some time to break down, delaying the bioavailability of its constituents. If applied in chipped form, the polyhalite tends to be of irregular shape and size, meaning that there can be difficulties in applying it uniformly, and meaning that it can be difficult to apply using some types of agricultural spreading machinery. Powdered polyhalite is difficult to spread evenly in an agricultural application, and since polyhalite powder can be hygroscopic its mechanical properties can vary quickly and radically over time once exposed to air.

It would be desirable to have a fertiliser product which is readily spreadable and provides a number of nutrients in a manner that is particularly beneficial to plants.

According to a first aspect of the present invention there is provided a fertiliser pellet comprising: a first fertiliser composition capable of providing (a) two or more alkali metal and/or alkaline earth metal nutrients and (b) sulphur; a second fertiliser composition capable of providing a first micronutrient; and a third fertiliser composition capable of providing a second micronutrient, the third fertiliser composition having a lower solubility than the second fertiliser composition.

According to a second aspect of the present invention there is provided a fertiliser pellet comprising: a first fertiliser composition capable of providing (a) two or more alkali metal and/or alkaline earth metal nutrients and (b) sulphur, the first fertiliser composition being polyhalite; a second fertiliser composition capable of providing a first micronutrient; and a third fertiliser composition capable of providing a second micronutrient, the third fertiliser composition having a lower solubility than the second fertiliser composition.

The first, second and third fertiliser compositions may be mixed together. The fertiliser pellet may comprise a first region and a second region adhered to the exterior of the first region, the first region comprising the first fertiliser composition and the second fertiliser composition and the second region comprising the third fertiliser composition. The fertiliser pellet may comprise a first region and a second region adhered to the exterior of the first region, the first region may comprise the first fertiliser composition and the third fertiliser composition and the second region may comprise the second fertiliser composition.

According to a third aspect of the present invention there is provided a fertiliser pellet comprising: a first region comprising a first fertiliser composition capable of providing (a) two or more alkali metal and/or alkaline earth metal nutrients and (b) sulphur, and a second fertiliser composition capable of providing a first micronutrient; and a second region adhered to the exterior of the first region, the second region comprising a third fertiliser composition capable of providing a second micronutrient.

According to a fourth aspect of the present invention there is provided a fertiliser pellet comprising: a first region comprising a first fertiliser composition capable of providing (a) two or more alkali metal and/or alkaline earth metal nutrients and (b) sulphur, the first fertiliser composition being polyhalite, and a second fertiliser composition capable of providing a first micronutrient; and a second region adhered to the exterior of the first region, the second region comprising a third fertiliser composition capable of providing a second micronutrient.

The first and second micronutrients may be the same. The first and second micronutrients may be different.

The first micronutrient may be selected from zinc, boron, manganese, molybdenum, copper and iron. The second micronutrient may be selected from zinc, boron, manganese, molybdenum, copper and iron. The second region may contact the first region over substantially the whole of its interface to the first region. The second region may substantially surround the first region.

The first fertiliser composition may be a mineral powder. The powder may be a powder of an evaporate mineral. The powder may be polyhalite. The fertiliser pellet may comprise more than 80% by weight of the first fertiliser composition. The fertiliser pellet may comprise less than 5% by weight of the first and second micronutrients.

According to a third aspect of the present invention there is provided a fertiliser product comprising a plurality of pellets as herein described. According to a fourth aspect of the present invention there is provided a pelletised fertiliser product wherein at least 50% of the pellets are pellets as herein described.

The present invention will now be described by way of example with reference to the accompanying drawings. In the drawings:

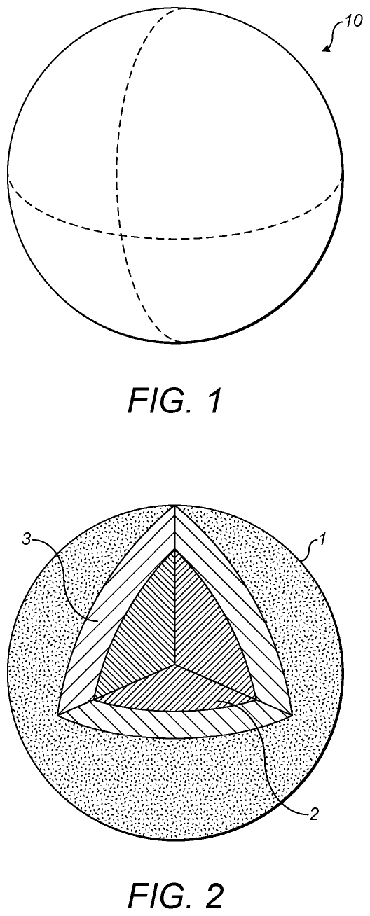

FIG. 1 shows a view of a first composite fertiliser pellet.

FIG. 2 shows a cut-away view of a second composite fertiliser pellet.

The following description is presented to enable any person skilled in the art to make and use the invention, and is provided in the context of a particular application.

Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The fertiliser product to be described below is composed of solid pellets.

In a first preferred example, each pellet comprises at least three fertiliser compositions. These fertiliser compositions may be mixed together to form a mixture of the fertiliser compositions within the pellets. FIG. 1 shows an example of the first preferred example pellet. The pellet 10 comprises a mixture of fertiliser compositions. The dotted lines illustrate the generally spherical nature of the pellet.

In second preferred example, each pellet comprises a core that comprises at least two fertiliser compositions over which is a layer that comprises at least a third fertiliser composition. The fertiliser compositions in the core of the pellet may be mixed together to form a mixture of the fertiliser compositions. FIG. 2 shows an example of the second preferred example pellet. The pellet 1 comprises a core 2 that comprises a mix of at least two fertiliser compositions. Over the core is a layer 3 that comprises at least a third fertiliser composition. The pellets can be spread on crops, on a seedbed or similar to act as a plant fertiliser.

The first fertiliser composition may be polyhalite. Polyhalite is principally a source of potassium, magnesium, calcium and sulphur. The second fertiliser composition is capable of providing a first micronutrient. Thus, the second fertiliser composition is a source of the first micronutrient. The third fertiliser composition is capable of providing a second micronutrient. Thus, the third fertiliser composition is a source of the second micronutrient. The second and third fertiliser compositions may be capable of providing the same micronutrient. In this case, the first micronutrient and the second micronutrient are the same. The second and third fertiliser compositions may instead be capable of providing different micronutrients. In this case, the first micronutrient and the second micronutrient are different. The fertiliser pellets may comprise more than two micronutrients. In this case, the pellets may comprise more than three fertiliser compositions and so may comprise a fourth or more fertiliser composition.

The second and third fertiliser compositions may have different solubilities. For instance, the third fertiliser composition can have a lower solubility relative to the second fertiliser composition. Solubility may be a measure of the ability of the fertiliser composition to dissolve in water. A composition with a higher solubility dissolves quicker in water than a composition with a lower solubility.

Studies undertaken by the applicant indicate that providing a fertiliser that has polyhalite in combination with two other fertiliser compositions that provide micronutrients and have different solubilities can be particularly beneficial for plant grows and development even with only a single spreading operation. In particular it has been observed that this combination leads to a slower release of some or all of the nutrients present in the fertiliser pellet. It is believed that this is due to one or more of the following factors. First, when the three fertiliser compositions are mixed together, as shown in FIG. 1, the micronutrient fertiliser composition with the higher solubility may break down first providing a first release of that micronutrient. As this fertiliser composition is mixed through the mixture of the polyhalite and the other micronutrient fertiliser composition, this causes the pellet to start to break down into segments. This increases the surface area of the pellet which then assists in the breaking down of the polyhalite and the micronutrient fertiliser composition that has a lower solubility. This therefore assists in providing a sustained release of the nutrients contained in the fertiliser pellet over time. Second, when the one of the micronutrient fertiliser compositions is present in the core 2 along with the polyhalite and the other micronutrient fertiliser composition is present in the layer 3 overlying the core, the fertiliser composition in the layer 3 can serve to protect the core from breaking down until the layer 3 itself has been broken down. The solubility of the two micronutrient fertiliser compositions can be chosen to give the required release profile for the nutrients contained in the pellet. For instance, having a lower solubility layer outside of the core would mean that the pellet could initially take longer to break down in the growing medium meaning the release of the nutrients contained in the polyhalite would be slowed down as it would take longer for the polyhalite to be exposed to the growing medium. Having a higher solubility layer in the layer 3 outside of the core means that there can be an injection of the micronutrient into the growing medium quickly followed by a slower release from the core 2. Furthermore, soil acidity (governed by pH) influences the solubility of each micronutrient and hence the release rates from the pellet.

Studies undertaken by the applicant also indicate that providing a fertiliser that has polyhalite in the core 2 along with one micronutrient fertiliser composition and a layer of a micronutrient fertiliser composition on the layer 3 outside of the core 2 is advantageous even in cases where the solubility of the two micronutrient fertiliser compositions are the same. This may be because they are the same micronutrient fertiliser composition. In this case, it is believed that it is because the layer 3 outside of the core 2 provides a large surface area for the initial supply of the micronutrient followed by a smaller surface area of both the micronutrient and polyhalite. This means that inherently it is more difficult for the core 2 to be broken down relative to the layer 3 outside of the core 2. This provides the initial supply of the micronutrient followed by the slower release of more micronutrient in combination with the fertiliser elements of the polyhalite that are contained in the core 2.

In general, the fertiliser pellet may comprise a mixture of all three fertiliser compositions. In this way the three fertiliser compositions may be homogeneously dispersed through the fertiliser pellet. Alternatively, the fertiliser pellet may comprise a mixture of polyhalite with a second fertiliser composition capable of providing a first micronutrient in a first region and a second region adhered to the exterior of the first region. The polyhalite and the second fertiliser may be homogeneously dispersed through the first region. The second region comprising a third fertiliser composition capable of providing a second micronutrient. In each case, the fertiliser pellet may comprise more than 35% of polyhalite by weight, more than 50% of polyhalite by weight, more than 75% of polyhalite by weight, more than 80% of polyhalite by weight, more than 85% of polyhalite by weight, more than 90% of polyhalite by weight, or more than 95% polyhalite by weight. In addition, to polyhalite and one or more of the other fertiliser compositions the pellet, or first region, may contain a binder and/or other constituents. These constituents may be homogeneously dispersed through the pellet or first region.

The second and third fertiliser compositions are capable of providing first and second micronutrients. The micronutrients provided by the second and third fertiliser compositions may be the same micronutrient. Advantageously, the second and third fertiliser compositions are different whilst providing the same micronutrient. This enables the delivery of the micronutrient to the growing medium to be tuned. In alternative embodiments, the micronutrient provided by the second and third fertiliser compositions may be different. Thus, in this case, the second and third fertiliser compositions will be different fertiliser compositions. The pellets may further comprise four micronutrients, and thus the pellets may comprise a second, third, fourth and fifth fertiliser compositions that each provide one micronutrient. Preferably, the micronutrient(s) may be selected from the group of zinc, boron, manganese, molybdenum, copper and iron. Additionally, the micronutrient(s) may be selected form the group of sodium, nickel, chlorine, cobalt, silicon, vanadium and selenium. As discussed herein, it is preferable that the second and third fertiliser compositions have different relative solubilities. Table 1 lists example fertiliser compositions that can be used to provide particular micronutrients and their solubility.

TABLE 1

| Micronutrient | Fertiliser composition | Solubility |
|---|---|---|
| Zinc | Zinc Sulphate (ZnSO₄) | Soluble |
| | Zinc Oxide (ZnO) | Insoluble |
| | Zinc EDTA (C₁₀H₁₂N₂O₈Zn⁻²) | Soluble |
| Boron | Colemanite (Ca₂B₆O₁₁) | Slightly Soluble |
| | Borax (Na₂B₄O₇) | Soluble |
| | Boric Acid (H₃BO₃) | Soluble |
| Manganese | Manganese Oxide (MnO) | Insoluble |
| | Manganese Carbonate (MnCO₃) | Insoluble |
| | Manganese Sulphate | Soluble |
| | Manganese EDTA (C₁₀H₁₆MnN₂O₈⁺²) | Soluble |
| Molybdenum | Molybdenum Trioxide (MoO₃) | Insoluble |
| | Sodium Molybdate Dihydrate (Na₂MoO₄•2H₂O) | Soluble |
| | Ammonium Molybate ((NH₄)₂MoO₄) | Soluble |
| Copper | Copper Oxide (CuO) | Insoluble |
| | Copper Sulphate (CuSO₄) | Soluble |
| Iron | Iron Sulphate (FeSO₄) | Soluble |
| | Iron EDTA (C₁₀H₁₂FeN₂O₈⁻) | Soluble |

As detailed herein, it can be advantageous for the second and third fertiliser compositions to have different solubilities. Both of second and third fertiliser compositions may provide the same micronutrient and one of the second and third fertiliser compositions can be selected to have a higher solubility than the other of the second and third fertiliser compositions. Where the micronutrient is zinc, the second fertiliser composition is capable of providing zinc and has a higher solubility than the third fertiliser composition and the third fertiliser composition is capable of providing zinc and has a lower solubility than the second fertiliser composition. For instance, the second fertiliser composition may be zinc sulphate or Zinc EDTA and the third fertiliser composition may be zinc oxide. Where the micronutrient is boron, the second fertiliser composition is capable of providing boron and has a higher solubility than the third fertiliser composition and the third fertiliser composition is capable of providing boron and has a lower solubility than the second fertiliser composition. For instance, the second fertiliser composition may be borax or boric acid and the third fertiliser composition may be colemanite. Where the micronutrient is manganese, the second fertiliser composition is capable of providing manganese and has a higher solubility than the third fertiliser composition and the third fertiliser composition is capable of providing manganese and has a lower solubility than the second fertiliser composition. For instance, the second fertiliser composition may be manganese sulphate or manganese EDTA and the third fertiliser composition may be manganese oxide or manganese carbonate. Where the micronutrient is molybdenum, the second fertiliser composition is capable of providing molybdenum and has a higher solubility than the third fertiliser composition and the third fertiliser composition is capable of providing molybdenum and has a lower solubility than the second fertiliser composition. For instance, the second fertiliser composition may be sodium molybdate dihydrate or ammonium molybate and the third fertiliser composition may be molybdenum trioxide. Where the micronutrient is copper, the second fertiliser composition is capable of providing copper and has a higher solubility than the third fertiliser composition and the third fertiliser composition is capable of providing copper and has a lower solubility than the second fertiliser composition. For instance, the second fertiliser composition may be copper sulphate and the third fertiliser composition may be copper oxide. Where the micronutrient is iron, the second fertiliser composition is capable of providing iron and has a higher solubility than the third fertiliser composition and the third fertiliser composition is capable of providing iron and has a lower solubility than the second fertiliser composition. The second and third fertiliser compositions may provide a different micronutrient each. In this case, one of the two micronutrient fertiliser compositions may be selected to have a lower solubility relative to the other and the above descriptions apply with the selected micronutrients substituted in the relevant places.

The fertiliser pellet may contain from 0.01 to 5% of the micronutrient by weight. The fertiliser pellet may contain at least 0.03% of the micronutrient by weight, at least 0.05%, at least 0.1%, at least 0.2%, or at least 1%. The fertiliser pellet may contain no more than 5% of the micronutrient by weight, no more than 3%, no more than 2%, no more than 1%, no more than 0.8%, no more than 0.5%, no more than 0.1%, or no more than 0.05%.

The amount of a micronutrient that is desirable to include in the fertiliser pellet may be different depending on the type of micronutrient. Advantageously, if the micronutrient is zinc then the fertiliser pellet may contain between 0.5% and 4% of zinc by weight, and more preferably between 1% and 2% of zinc by weight. Advantageously, if the micronutrient is boron then the fertiliser pellet may contain between 0.1% and 1% of boron by weight, and more preferably between 0.2% and 0.5% of boron by weight. Advantageously, if the micronutrient is manganese then the fertiliser pellet may contain between 0.05% and 1.6% of manganese by weight, and more preferably between 0.1% and 0.8% of manganese by weight. Advantageously, if the micronutrient is molybdenum then the fertiliser pellet may contain between 0.005% and 0.1% of molybdenum by weight, and more preferably between 0.01% and 0.05% of molybdenum by weight. Advantageously, if the micronutrient is copper then the fertiliser pellet may contain between 0.01% and 6% of copper by weight, and more preferably between 0.03% and 3% of copper by weight. Advantageously, if the micronutrient is iron then the fertiliser pellet may contain between 0.01% and 6% of iron by weight, and more preferably between 0.05% and 3% of iron by weight. If two different micronutrients are included in the fertiliser pellet then the amount of each micronutrient listed may be halved or the same quantity as listed above of each micronutrient may be included.

The ratio of the second fertiliser composition capable of providing the first micronutrient relative to the third fertiliser composition capable of providing the second micronutrient may be varied. The fertiliser pellet may comprise the second fertiliser composition in a ratio of 1:3 to the third fertiliser composition. The fertiliser pellet may comprise the second fertiliser composition in a ratio of 1:1 to the third fertiliser composition. The fertiliser pellet may comprise the second fertiliser in a ratio of 3:1 to the third fertiliser composition.

In the case that the fertiliser pellet is as shown in FIG. 2 with a core 2 and a layer 3 adhered to the outside of the core 2, in general the composite pellet 1 may comprise the following:
A first region 2 that comprises a first fertiliser composition that provides (i) two or more alkali metals and/or alkaline earth metals and (ii) sulphur. The first region may act as a fertiliser that provides (i) three or more alkali metals and/or alkaline earth metals and (ii) sulphur. The first region may act as a fertiliser that provides (i) one or more alkali metals (ii) two or more alkaline earth metals and (ii) sulphur. The second first region may, for example, comprise more than 30% alkali metals and alkaline earth metals by weight, and more than 15% or more than 20% sulphur by weight.
The first region 2 that also comprises a second fertiliser composition that provides a first micronutrient.
A second region 3 acting as a third fertiliser composition that provides a second micronutrient.

Preferably the first region is substantially soluble in or degradable by water. Preferably the second region is substantially soluble in or degradable by water. Where the first region comprises powder bound together with a binder, the binder may be water-soluble. Where the second region comprises powder bound together with a binder, the binder may be water-soluble.

The core may be of any desired shape, but conveniently it is substantially spherical. For example, it may have a Wadell sphericity of 0.9 or above.

The size of the core may be such that it has a largest dimension less than 5 mm, less than 4 mm, less than 3 mm, less than 2 mm or less than 1 mm. The size of the core may be such that it has a smallest dimension greater than 4 mm, greater than 3 mm, greater than 2 mm, greater than 1 mm or greater than 0.5 mm. The volume of the core may be less than 20 mm³, less than 15 mm³, less than 10 mm³, less than 8 mm³ or less than 5 mm³. The volume of the core may be greater than 15 mm³, greater than 10 mm³, greater than 8 mm³, greater than 5 mm³ or greater than 1 mm³. Other dimensions could be adopted.

Preferably the coating layer 3 entirely covers the inner region or core 2. In a bulk product the core may be entirely covered by the outer layer in, for example, more than 90%, more than 95% or more than 99% of the pellets of the bulk product.

Preferably the outer layer 3 is in contact with the majority of the outer surface of the inner region 2. Alternatively there may be an intermediate layer between the inner region and the outer layer. Such an intermediate layer may be a layer of a binder and/or adhesive such as PVA or starch.

Preferably the outer layer 3 is of a substantially uniform thickness. The maximum thickness of the outer layer may be less than 5 mm, less than 4 mm, less than 3 mm, less than 2 mm, less than 1 mm or less than 0.5 mm. The minimum thickness of the outer layer may be greater than 4 mm, greater than 3 mm, greater than 2 mm, greater than 1 mm, greater than 0.5 mm or greater than 0.1 mm. The volume of the outer layer may be less than 20 mm³, less than 15 mm³, less than 10 mm³, less than 8 mm³ or less than 5 mm³. The volume of the outer layer may be greater than 15 mm³, greater than 10 mm³, greater than 8 mm³, greater than 5 mm³ or greater than 1 mm³. Other dimensions could be adopted.

The pellet, with or without the core and outer layer structure, may be of any desired shape, but conveniently it is substantially spherical. For example, it may have a Wadell sphericity of 0.9 or above. The size of the pellet may be such that it has a largest dimension less than 10 mm, less than 7 mm, less than 6 mm, less than 5 mm or less than 4 mm. The size of the pellet may be such that it has a smallest dimension greater than 6 mm, greater than 5 mm, greater than 4 mm, greater than 3 mm or greater than 1 mm. The volume of the pellet may be less than 70 mm³, less than 60 mm³, less than 50 mm³, less than 40 mm³ or less than 30 mm³. The volume of the pellet may be greater than 20 mm³, greater than 30 mm³, greater than 40 mm³, greater than 50 mm³ or greater than 60 mm³. Other dimensions could be adopted.

The size of the pellet and, in the cases that they are present, the relative sizes of the core 2 and the outer layer 3 can be selected for best performance in the environmental conditions and on the crop for which the fertiliser is intended.

In the case of a fertiliser in bulk, the values given above for the sizes, shapes and relationship between the core 2 and the outer layer 3 may be mean or median values over the bulk. Alternatively, greater than 50%, greater than 80% or greater than 90% of the particles of the bulk fertiliser may be taken to have the requisite value(s). In the case of a fertiliser in bulk, the values given above for the size and shape of the pellet itself may be mean or median values over the bulk. Alternatively, greater than 50%, greater than 80% or greater than 90% of the particles of the bulk fertiliser may be taken to have the requisite value(s).

There could be a coating over the exterior of the micronutrient layer 3, or the exterior of the pellet. That could, for example, be a sealant (e.g. to resist breakdown of the pellet in transit) or a lubricant (e.g. to assist in spreading of the pellet). The coating could be water-soluble so that it degrades readily when the pellet is spread on a crop or growing medium.

As indicated above, polyhalite is a complex hydrated sulphate of potassium, calcium and magnesium of general formula K₂Ca₂Mg(SO₄)₄.2H₂O. Polyhalite has a Moh's hardness of around 2.5 to 3.5. Polyhalite can be extracted from natural reserves by mining. As-mined polyhalite may be intimately combined with other minerals which form impurities in the polyhalite. These other minerals are preferable in low proportions (e.g. less than 10% or less than 5% in good quality ore.) Once mined, the polyhalite may be broken into blocks or chips of suitable size for transport and processing. For example, the as-mined rock may be fed to crushers such as jaw crushers and/or cone crushers in order to yield a chipped material of generally uniform size. It has been found that chips of largest dimension no greater than around 20 mm and/or of average dimension between 5 and 10 mm are convenient for transportation from a mine. The chips can be transported by conveyor, trucks or any other convenient mechanism.

The raw or chipped polyhalite is processed to form a powder essentially of polyhalite. This may suitably be done using high pressure grinding roller (HPGR) equipment, or in a ball mill (e.g. a continuous “Hardinge” ball mill) or an attritor mill. The average grain size of the powder is dependent on various process parameters including the dwell time of the feedstock in the powdering equipment and the configuration of the powdering equipment. Oversized particles exiting the powdering equipment may be returned to the equipment for further processing. The desired powder size will depend on the nature of the subsequent processing steps, but it has been found that screening the output of the powdering process with a 500 μm screen and accepting the material passing the screen for further processing yields good results. Oversized particles exiting the powdering equipment and not passing the screen may be returned to the powdering equipment for further processing. A convenient profile of the powder passed to the next step of the process is: 100% passing a 500 μm screen and 80% (by mass) passing a 200 μm screen. Conveniently at least 50% or more preferably at least 70% of the mass of the powder is composed of grains having a grain size, or a largest or average diameter, in the range from 50 to 400 μm, more preferably from 100 to 250 μm. The grain size may be as measured by means of a Malvern Mastersizer 2000 or as measured by means of a sieve shaker.

Impurities in the mined rock may be separated before the mined rock is powdered. Alternatively, if the impurities are in reasonably low proportion to the desired mineral then it may be retained and powdered. Thus, the powdered polyhalite may comprise other minerals too.

In the case of the final pellet comprising a mixture of the fertiliser compositions together with no central core, at least two fertiliser compositions comprising micronutrient(s) are added to the powered polyhalite in amounts by weight specified herein. In the case of the final pellet comprising a core and a layer adhered to the core, at least one fertiliser composition comprising micronutrient(s) are added to the powered polyhalite in amounts by weight specified herein. The fertiliser composition(s) are in the form of a powder.

Water and a binder are added to the powered polyhalite. In the description below, the additions of water and binder are specified by mass with reference to the mass of the powder to which they are added. The amount of water to be added will depend on the inherent water content of the powdered polyhalite and the nature of the subsequent processing steps. However, it has been found that when the binder is a starch-based binder such as starch itself or flour, acceptable results can be achieved by adding water in the range of 5% to 10%, more preferably between 7% and 8%. At a subsequent stage in the process excess water is removed from the formed pellets by drying. That can consume energy, so it is preferred to minimise the amount of water added, provided that is consistent with the production of an acceptably bound pellet product. The preferred amount of water can readily be determined by testing. The amount of binder to be added will depend on the qualities of the binder. For typical binders, e.g. starch or flour, the amount added may be in the range of 0.5% to 1.5%. The binder may be a starch-based binder such as a purified starch or a flour, or an adhesive such as PVA. The binder may be added directly to the powder, or it may first be added to the water and then the water and binder combination may be added to the powder.

The powder/binder mixture is mixed until it is homogeneous, and pelletised. In one approach, the powder/binder mixture is mixed in a suitable mixer (e.g. a ribbon blender) and then pelletised in a suitable pelletiser (e.g. a pan pelletiser). In an alternative approach, which has been found to be efficient, the powder/binder mixture is passed to equipment that can both mix and pelletise. An example of such equipment is an intensive mixer/granulator, e.g. as available from Maschinenfabrik Gustav Eirich GmbH & Co KG. A pelletiser may be configured to expel processed material as it operates, allowing it to run continuously. Alternatively, the pelletiser may operate on a batch basis, with material being processed according to a defined programme and then expelled en masse.

At completion of the pelletising process, the pellets are expelled from the pelletiser. The material expelled from the pelletiser can be screened to separate undersized or oversized pellets from pellets of a desired size range. The desired size range may, for example, be that which passes a 4 mm screen but does not pass a 2 mm screen. Alternatively, other sizes may be chosen as appropriate to the desired application. The outsized pellets may be recirculated. Any pellets that are oversize can be ground and then returned to the pelletiser. Undersize pellets can be returned directly to the pelletiser.

The output of the pelletiser is wet, substantially spherical pellets.

In the case of the final pellet comprising a mixture of fertiliser compositions together with no central core, the pellets that meeting desired size are conveniently dried before packaging. To achieve this the pellets that have been output from the pelletiser can be passed to a drier. It has been found that a retention time of around 3 minutes in a drier capable of heating the pellets to a temperature of around 150° C. is sufficient to adequately dry the pellets. This can harden them. Pellets manufactured using polyhalite powder and with flour as a binder can have a crush strength in excess of 4.0 kgf and/or in excess of 5.0 kgf. This compares favourably with a generally accepted lower limit of 2.2 kgf for acceptable agricultural pellets. Moisture can be extracted from the dryer using a reverse jet air filter. The operating temperature and retention time in the dryer can be selected to provide pellets of the desired strength for subsequent handling.

In the case of the final pellet comprising a core and a layer adhered to the core, once the pellets comprising polyhalite and at one fertiliser composition comprising micronutrient(s) have been formed, these pellets are processed to cause the coating of those pellets with the second fertiliser composition. One way in which this can be done is to tumble the pellets with the second fertiliser composition power. For example, in a horizontal or sloping rotary drum mixer which is driven to rotate about its main axis. The moisture content of the powder and the speed of the mixer can be selected so that the pellets are effectively coated with the mixture. The dwell time of the pellets in the mixer can be selected so that the pellets are provided with the desired thickness of second fertiliser composition coating. The axis of the mixer drum can be inclined so that material fed to the upper end of the drum will migrate to the lower end where it can be discharged. Hot air can be fed to the interior of the drum, for example to its lower end, or heat can be applied to the exterior of the drum. In this way the composite pellets can be dried so as to harden and stabilise them. The region of the drum to which the wet mixture is fed may be smooth-walled so that the pellets roll against the interior of the drum to round off. The lower region of the drum may be provided with vanes or lifters that protrude inwardly from the walls of the drum. These lift the pellets as the drum rotates and drop them into the warm air in the drum, facilitating drying. On exiting the drum the pellets have been rounded and dried to a suitable hardness for shipping. The dryer may be the same apparatus as is used to combine the pellets and fertiliser composition power, or a separate device.

Other methods to coat the pellet cores could be used. For example, the fertiliser composition powder could be applied to a pan pelletiser together with the pellets, and the pan pelletiser can then be run to yield a collection of pellets of the appropriate size. Again, the moisture content of the mixture and the speed and inclination of the pelletiser should be selected to provide composite pellets of the desired size.

Once the composite pellets have been formed they may then be screened to separate out under-size and over-size pellets. The undersize pellets can be returned to the mixer where the pellet cores are combined with the fertiliser composition powder.

Finally, the in-size pellets can be cooled and packaged, for example in 600 kg bags or 25 kg sacks, or shipped loose for use or further processing elsewhere. The pellets can be supplied for agricultural use. Eventually they can be spread on a field or other agricultural or horticultural substrate to act as a fertiliser. The composite pellets may be used for purposes other than fertilisation.

Other additives may be included in the pellets. Such additives may one or more of the following, in any combination:
a component having the effect of chemically and/or mechanically stabilising and/or preserving the pellets: for example to increase their shelf life, reduce their susceptibility to environmental contaminants or to reduce the likelihood of them being broken up during spreading (e.g. a pH buffer);
a component having the effect of enhancing the fertilising effect of the polyhalite and/or the fertiliser compositions providing micronutrient(s): for example by accelerating or retarding the breakdown of the polyhalite in the field;
a component having the effect of protecting or enhancing the growth of crops by means other than fertilising: for example a herbicide, fungicide, insecticide, rodenticide, hormone, plant stimulant or mycorrhizal fungus or spore;
a seed: which may be a seed of an angiosperm, gymnosperm and/or of a crop species (e.g. a cereal such as wheat, maize, rice, millet, barley, oats or rye);
a further fertiliser composition providing macro or micronutrients in addition to the polyhalite and fertiliser compositions providing macro or micronutrients;
a pigment;
a component having the effect of altering soil pH: for example lime or sulphur.

Such a component may be added at any suitable stage in the process. For example it could be combined with the polyhalite powder prior to or during a mixing stage as described above, or with the polyhalite/binder mix, or it could be added to the extruder, or it could be sprayed or otherwise coated on to the pellets before or after drying.

The composite pellets are preferably substantially free from voids, for example having not more than 1%, 2% or 5% by volume of air.

The process as described above may be used for producing pellets with a core of a mineral other than polyhalite, and in particular for producing pellets with a core composed principally of one or more evaporite minerals, especially other chloride minerals. These may include any one or more of Anhydrite, Carnalite, Gypsum, Halite, Kainite, Kieserite, Langbeinite and/or Sylvite.

Where a property is specified above in respect of a single pellet, that criterion may be applied in the case of a bulk pelletised fertiliser as (i) the mean value over the bulk, (ii) the median value over the bulk, or (iii) by more than 50% or more than 80% of the pellets of the bulk fertiliser having the requisite property.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A fertiliser pellet comprising:
a first fertiliser composition capable of providing (a) two or more alkali metal and/or alkaline earth metal nutrients and (b) sulphur, the first fertiliser composition being polyhalite;
a second fertiliser composition capable of providing a first micronutrient; and
a third fertiliser composition capable of providing a second micronutrient, the third fertiliser composition having a lower solubility than the second fertiliser composition.

2. The fertiliser pellet as claimed in claim 1, wherein the first,
second and third fertiliser compositions are mixed together.

3. The fertiliser pellet as claimed in claim 1, the fertiliser pellet comprising a first region and a second region adhered to the exterior of the first region, the first region comprising the first fertiliser composition and the second fertiliser composition and the second region comprising the third fertiliser composition.

4. The fertiliser pellet of claim 2, the fertiliser pellet comprising a first region and a second region adhered to the exterior of the first region, the first region comprising the first fertiliser composition and the third fertiliser composition and the second region comprising the second fertiliser composition.

5. A fertiliser pellet comprising:
a first region comprising a first fertiliser composition capable of providing (a) two or more alkali metal and/or alkaline earth metal nutrients and (b) sulphur, the first fertiliser composition being polyhalite, and a second fertiliser composition capable of providing a first micronutrient; and
a second region adhered to the exterior of the first region, the second region comprising a third fertiliser composition capable of providing a second micronutrient.

6. The fertiliser pellet of claim 1, wherein the first and second micronutrients are the same.

7. The fertiliser pellet of claim 1, wherein the first and second micronutrients are different.

8. The fertiliser pellet of claim 1, wherein the first micronutrient is selected from zinc, boron, manganese, molybdenum, copper and iron.

9. The fertiliser pellet of claim 1, wherein the second micronutrient is selected from zinc, boron, manganese, molybdenum, copper and iron.

10. The fertiliser pellet of claim 3, wherein the second region contacts the first region over substantially the whole of its interface to the first region.

11. The fertiliser pellet of claim 3, wherein the second region substantially surrounds the first region.

12. The fertiliser pellet of claim 1, wherein the first fertiliser composition is a mineral powder.

13. The fertiliser pellet as claimed in claim 12, wherein the powder is a powder of an evaporate mineral.

14. The fertiliser pellet as claimed in claim 12, wherein the powder is polyhalite.

15. The fertiliser pellet of claim 1, wherein the fertiliser pellet comprises more than 80% by weight of the first fertiliser composition.

16. The fertiliser pellet of claim 1, wherein the fertiliser pellet comprises less than 5% by weight of the first and second micronutrients.

17. A fertiliser product comprising a plurality of pellets as claimed in claim 1.

18. A pelletised fertiliser product wherein at least 50% of the pellets are pellets as claimed in claim 1.
